(19) United States
(12) Patent Application Publication
(10) Pub. No.: US 2008/0292885 A1
(43) Pub. Date: Nov. 27, 2008

(54) Carrier Film of an Embossing Film

(75) Inventor: Dieter Dohring, Lampertswalde (DE)

Correspondence Address: RENNER OTTO BOISSELLE & SKLAR, LLP, 1621 EUCLID AVENUE, NINETEENTH FLOOR, CLEVELAND, OH, 44115, US

(73) Assignee: KRONOSPAN TECHNICAL CO. LTD., Engomi, Nicosia (CY)

(21) Appl. No.: 11/571,791

(22) PCT Filed: Jul. 8, 2004
(86) PCT No.: PCT/EP04/51420

§ 371 Date: Jan. 8, 2007

(51) Int. Cl. B32B 27/06

(52) U.S. Cl. 428/418

(57) ABSTRACT

The invention relates to an embossing film, in addition to an associated carrier film for applying surface structures, in particular to fibreboard. The invention also relates to a press and to a production method that uses the embossing film. The advantages of the inventive embossing film are that its use during the pressing process is low-maintenance and obtains a particularly even surface structure. In an additional embodiment, the embossing film has one or more metallic additives, in particular aluminium additives. This improves the strength of the film, in particular during the pressing process and improves the thermal conductivity of the embossing film. The heat that occurs or is produced during the pressing process for curing the resins that are used can thus be dissipated more efficiently from the panel. In a further embodiment, the embossing film comprises an acrylate, which increases the mechanical stability of said film. The acrylate can be applied in the form of a dispersion to the carrier film or paper and is pressed into the film or paper in a roller pressing process. The high mechanical stability permits the film to undergo the embossing operation several times, thus reducing production costs. In addition, the thickness of the film can be reduced, without any detrimental effect on the required stability. Said reduction also increases the thermal conductivity of the film, again reducing production costs.

The present invention relates to an embossing foil as well as to a corresponding carrier foil for embossing of surface structures and objects, in particular boards, for example boards made of wood fiber. The invention further relates to a pressing device, as well as to a manufacturing method which includes the use of the embossing foil. By means of the structure, it is for example achieved that in case of a panel the impression is given that it consists of natural wood, and it is thus communicated the quality of real wood parquet. Further, this structure may serve for reducing the reflection characteristics and to increase the robustness of the surface, since the latter is less scratch-prone in contrast to high gloss surfaces.

By means of an embossing foil, structures are applied to for example imitation leather or in the surface of a laminate panel for a flooring. The embossing foils which are known in the prior art, are also called structure applying papers and are used amongst others for the production of working panels, window sills, as well as in the field of furniture industry. However, it has become obvious that structure applying paper according to the prior art is not sufficiently thermally stable respectively not sufficiently thermally conductive. The structure applying papers according to the prior art comprise a mass per unit area of 60 to 250 g/m² of paper and comprise only a low thermal conductivity. Due to this drawback, the pressing has to be carried out slowly, which increases in the end the production costs.

Thus, it has so far been tried with relatively little success to apply the structures by means of the conventional structure applying papers in a continuous production with a double belt lamination plant or in a short cycle press onto a laminate panel. This applies all the more for laminate panels produced in direct coating processes. In direct coating, the decor paper is directly pressed together with the abrasion-resistant layer and the overlay and the board. In the other case, initially the uppermost layer is produced and glued with the board.

The known continuous methods for laminate production apply rotary, metallic press belts having a structured surface, for example with a pearl or screen structure, which have an embossing effect during pressing with the laminate panel onto the upper layer of the latter, for example the overlay. This procedure, however, comprises multiple disadvantages. Amongst others, the belts will have to be changed often due to wear reasons which interrupt the pressing procedure in a disadvantageous manner. Further, the structure is not sufficiently homogeneous, comprises errors and the surface of the laminate panel treated in this way loses quite often gloss after such a treatment.

With regard to the above-described disadvantages, it is thus the object of the present invention to provide a method as well as an embossing foil as well as a respective carrier foil, which enables a comparatively enhanced structural embossing of the object, especially of the laminate panel. This object is achieved by means of the generic carrier foil with the features of claim 1, a respective embossing foil according to claim 6, a pressing device according to claim 10 as well as the respective method according to claims 9 respectively 12. Advantageous embodiments results from the sub-claims.

The inventive carrier foil serves as carrier foil for an embossing foil. An embossing foil is suitable for an embossing application of structures onto a surface of an object. The objects are for example wood fiber panels in general, laminate panels, working panels, window sills, in particular panels in the furniture field etc. The inventive carrier foil comprises paper. In this way, the foil may on the one hand be produced particularly simple and cost-effective, amongst others because the devices for the treatment of the paper in the wood fiber panel industry are already present. Further, the applied paper comprises the advantage that it leaves no damages at the embossing respectively pressing devices, as for example pressing belts and so on. Further, the paper covers the surface of the object from undesired effects of the embossing device onto the surface of the object. For example, the surface gloss of a laminate panel is maintained, because the metallic belt presses do not directly act upon the uppermost layer, which in most cases is the so-called overlay.

In a further advantageous embodiment, the carrier foil comprises one or more metallic additives. In this way, it is achieved that on the one hand the rigidity of the foil, in particular during the embossing procedure is enhanced. On the other hand, the metallic additives enhance the thermal conductivity of the carrier foil. The heat which occurs during embossing may be removed better in this way. Further, the carrier foil will become comparatively more thermally resistant.

By means of the inventive carrier foil, structures may be applied in a continuous production with a double belt laminating apparatus or in a short cycle press onto a laminate panel. Further, laminate panels which are produced in a direct coating procedure may immediately be provided with a structure. During direct coating, the decor paper is pressed immediately together with the abrasion-resistant layer and the overlay and the panel. The heat necessary for curing the used resins is not harmful for the carrier foil. Punctual occurring overheating and crack formation connected therewith may even advantageously be removed due to the comparatively good thermal conductivity. The metallic additives may be applied in form of dispersion onto the embossing foil respectively the paper and may be pressed into the foil respectively the paper in a roll press procedure.

In a further embodiment of the inventive embossing foil, the latter comprises additives of aluminum. For example, aluminum is applied to the foil in the form of finest particles having a particle size of 500 nm to 500 μm in the average. The application of aluminum has proved to be particularly suitable with regard to the enhanced thermal conductivity. The thermal conductivity is suitably enhanced. This enables shorter pressing times, i.e. higher rates at the double belt presses.

In an embodiment, material of the trade name Aluminium slurry 8009/191 is used. The latter comprises an aluminum content of 16.2 weight percent, a particle size of several μm, a solids content of 32.8 weight percent, a viscosity (Ford, 4 mm) of 144 s, a density of 1.12 g/cm³ and a pH of 8.5.

In a further embodiment, the carrier foil comprises an acrylate. By means of the acrylate, the mechanical stability of the carrier foil is increased. The acrylate may be applied onto the carrier foil respectively paper in form of dispersion, and may be pressed into the foil respectively the paper in a roller press procedure. Due to the high mechanical stability, the carrier foil may pass through the embossing procedure a number of times. It has been found that in the direct coating procedure for laminate panels that carrier foil may pass through the pressing procedure up to thirty times without a notable deterioration. Theoretically, a passing through of up to sixty times should be possible with the carrier foil, wherein the production costs may be reduced. Further, the strength of the foil may be reduced without harming the sufficient stability of the latter. In this way, the thermal conductivity of the latter is advantageously increased, and the production costs are lowered. In this way, the mass per unit area of the paper used as carrier foil may substantially be reduced.

According to another advantageous embodiment, a thermally stable acrylate is used. An acrylate is thermally stable in the sense of the invention if the latter can be used in the press which is operated at temperatures of 185° C. The acrylate blend “Induprint PAC 907” of Indulor Chemie GmbH/Ankum in Germany has proved to be suitable. This is, according to the information of the producer, a dispersion based on methylmetacrylate, which has been carboxylated. It comprises according to DIN ISO 1625 a solids content of 39-41%, a viscosity at 20° C. (DIN 53019-1 Contraves-Rheometer STV, MS: A3) of less than 100 mPa·s, a pH (DIN ISO 976) of 4.0 to 5.0 as well as an acid number (DIN ISO 2114) with respect to the dispersion of 50-60 mg KOH/g.

In an advantageous embodiment, the foil respectively the paper comprises a mass per unit area of less than 60 g/m², in particular approximately 30 g/m². In this way, the production costs may be substantially lowered.

The invention further relates to an embossing foil. The inventive embossing foil comprises a carrier foil according to the above described embodiments, i.e. also with the above described advantageous effects. Further, there is provided a surface structure applied onto the carrier foil, which is suitable during pressing with a surface of an object to emboss a negative imprint of the structure into the surface of the object. The object may be a working panel, a window sill as well as a panel used in the field of furniture industry. For example, it is a laminate panel, i.e. a panel which comprises in its core phenol resin containing cellulose webs and melamine resin impregnated papers at its surfaces. The surface structure may be formed in such a way that the negative imprint of the latter is suitable to imitate the surface unevenness or the crack formation of a wood grain. Further, the surface structure may comprise an irregular pattern of line-shaped, pearl-shaped or screen-shaped unevenness. It is up to the skilled person to adapt the constitution of the structure in accordance to the visual and physical requirements to the plate. The embossing foil is suitable to emboss during pressing with the surface of the plate a negative imprint of its structure into the surface of the plate, in particular its overlay.

The embossing foil comprises the advantage that the application of the latter is particularly low in maintenance during embossing. Further, its application may substantially facilitate the pressing with a belt press. In contrast to the surfaces which have been treated with a metallic structured belt of a belt press, the structures which are produced by means of the inventive embossing foil are especially homogeneous and errors do not occur. Further, the smaller number of applications of the embossing foil ensure constant results in the negative imprint as compared to continuous rotary structured belts of a belt press. Further, the used paper comprises the advantage that it leaves no damages to the embossing devices, as for example press belts etc. Further, the paper protects the surface of the object from undesired effects of the embossing device onto the surface of the object. For example, the surface gloss is maintained in a laminate panel, since the metallic belt presses do not directly act upon the uppermost layer, which is in most cases the so-called overlay.

According to a further embodiment, the surface structure of a further layer applied onto the carrier foil is included. For example, there is applied onto the carrier foil a lacquer, in which the desired structures are embossed, in order to become embossing itself at a later stage. In this regard, conventional methods are applied which are known in the prior art.

Commercially available electron beam curing lacquers are preferably used since they have proven as suitable.

The invention further relates to a method for producing a carrier foil, wherein a dispersion of acrylate and/or metallic particles is pressed into the carrier foil. The metallic particles and the acrylate are applied in form of dispersion onto the embossing foil respectively the paper and are for example pressed into the foil respectively the paper in a roll press procedure. By means of the metallic particles it is achieved that on the one hand the rigidity of the foil is enhanced, in particular during the embossing procedure. On the other hand, the metallic additives enhance the thermal conductivity of the carrier foil. For example, aluminum is applied to the foil with a particle size of 1-160 μm.

In an embodiment, material with the trade name Aluminium slurry 8009/191 is used. The latter comprises an aluminum content of 16.2%, a particle size of several μm, a solids content of 32.8%, a viscosity (Ford, 4 mm) of 144 s, a density of 1.12 g/cm³ and a PH of 8.5. By means of the acrylate, the mechanical stability of the carrier foil is enhanced. The acrylate is applied in form of dispersion onto the carrier foil respectively the paper and is pressed into the foil respectively the paper in a roll press procedure. Due to the high mechanical stability, the carrier foil may pass through the embossing procedure several times. In one embodiment, a common dispersion of acrylate and metallic particles, in particular of aluminum may be produced.

In a raw paper of 30 g/m², the content of applied dispersion comprises typically 5-60 g/m², for example 15 g/m². The end mass is then for example 45 g/m². With a nip pressure of several bars, for example 0.5-5 bar, typically 1.5 bar, the dispersion is pressed into the paper.

The invention further relates to a press device for an embossing application of a surface structure onto an object. According to the invention, there are means provided for exerting a pressing pressure onto an object arranged in a pressing device.

Further, there is at least partly arranged an embossing foil between the means and the object in one of the embodiments described above. For example, the object is a wood fiber panel, which is provided with a surface structure by means of the inventive device. The pressing device with an embossing foil according to the above-described embodiments, comprises the advantage that by their application the pressing procedure may be carried out in an especially low maintenance manner. Further, the application may enhance the embossing result in such a way that the surface structure is particularly homogeneous. Further, there are provided metallic additives, in particular aluminum particles in the carrier foil belonging to the embossing foil. The latter enhance the thermal conductivity of the embossing foil. The heat which occurs respectively is generated during pressing for curing the used resins made in this way may be removed better from the panel. By means of the acrylate in the carrier foil, the latter is of comparatively higher mechanical stability and thermal stability. The carrier foil may be used several times, whereby the production costs may be lowered. Further, the strength of the foil may be reduced without harming the sufficient stability of the latter. In this way, additionally the thermal conductivity of the latter is advantageously increased and the production costs are lowered.

In a further advantageous embodiment, the means for exerting a pressing pressure comprise a belt press, for example a double belt press. The object is a wood fiber panel. The embossing foil covers in one embodiment at least partly a surface of the panel, which fits tightly to one of the rotary belts. A rotary belt of the belt press acts directly or via a pressing cushion onto the embossing foil and presses the latter in order to create the surface structure onto the surface of the wood fiber panel. The above-described foil comprises in combination with the belt press the advantages that the foil is synchronously processed with the panel by the belt press. The pattern constitution of the panel is advantageously determined only by the revolving embossing foil. In a belt being provided with an embossing structure amongst others, the length of the rotary band determines in a disadvantageous way the resulting structure of the panels passing through. Further, due to the use of the inventive embossing foil, the production costs may significantly be decreased, amongst others because the latter may be used several times.

The invention further relates to a method for producing an at least partly resin containing panel with surface structure, in particular a laminate panel, wherein the panel is pressed with an embossing foil in one of the above-described embodiments for generating a negative imprint in the panel surface, and after the pressing the embossing foil is removed from the panel. The application of an embossing foil according to the above-described embodiments comprises the advantage that by their application the pressing procedure may be carried out in a particularly low maintenance manner. If further metallic additives, especially aluminum particles, are provided in the embossing foil, the latter enhances the thermal conductivity of the embossing foil. The heat which occurs respectively is generated during pressing for curing the used resins, may in this way advantageously be removed from the panel.

In a further embodiment, the pressing occurs by means of a band press. The above-described foil comprises in combination with the belt press the advantages that the foil is processed synchronously with the panel by the belt press. The pattern constitution of the panel is advantageously only determined by the revolving foil. In a belt being provided with an embossing structure amongst others, the length of the rotary belt determines disadvantageously the resulting structure of the panel passing through. The inventive embossing foil may advantageously be applied in particular in a continuous production with a double belt laminating apparatus. This applies especially for direct coating procedures by means of which laminate panels are produced. In direct coating, the decor paper is directly pressed together with the abrasion-resistant layer and the overlay and the panel.

During the production with a double belt laminating apparatus, the embossing foil is for example unrolled from the one drum and is rolled up again by the other drum. Arranged in-between is the double belt laminating apparatus. The embossing foil is fed to the double wall laminating apparatus as well as the other components, i.e. the decor paper, the counter acting paper as well as the panels. If the embossing foil is applied in connection with the pressing means in a double belt laminating apparatus, the latter protects the pressing belts from damages, as for example through the abrasion-resistant layer, which is usually applied onto the laminate. The maintenance of the metallic belts is consequently not necessary that often. Also in this manner, the costs are reduced.

1. Carrier foil for an embossing foil for embossing laminate panels, wherein the carrier foil comprises paper, characterized in that a dispersion comprising metallic particles is pressed into the carrier foil.

2. Carrier foil according to claim 1, wherein the metal is aluminum.

3. Carrier foil according to claim 1, which comprises an acrylate.

4. Carrier foil according to claim 1, wherein the acrylate is thermally stable.

5. Carrier foil according to claim 1, wherein the foil comprises a mass per unit area of less than 60 g/m2, in particular of approximately 30 g/m2.

6. Embossing foil with a carrier foil claim 1, with a surface structure applied onto the carrier foil which, during pressing with a surface of an object, is suitable for embossing a negative imprint of its structure into the surface of the object.

7. Embossing foil according to claim 1, wherein the surface structure is comprised by a further layer being applied to the carrier foil.

8. Pressing device for an embossed application of a surface structure to an object including means for exerting a pressure onto an object arranged within the pressing device, wherein an embossing foil according to claim 6 is arranged at least partially between the means and the object.

9. Pressing device according to claim 8, wherein the means for exerting a pressure comprises a belt press.

10. Use of the embossing foil according to claim 6 for producing a laminate panel.

11. Use according to claim 10, wherein the pressing is achieved by means of a belt press.

12. Method for producing a carrier foil according to claim 1, wherein a dispersion is pressed into the carrier foil which comprises an acrylate and/or metallic particles.
